(19) United States
(12) Patent Application Publication
(10) Pub. No.: US 2008/0025053 A1
(43) Pub. Date: Jan. 31, 2008

(54) Uninterruptible power supply with transient suppression

(76) Inventor: Michael W. Januszewski, Downers Grove, IL (US)

Correspondence Address: MCCRACKEN & FRANK LLP, 200 W. ADAMS STREET, SUITE 2150, CHICAGO, IL, 60606, US

(21) Appl. No.: 11/881,169

(22) Filed: Jul. 25, 2007

Related U.S. Application Data
(60) Provisional application No. 60/820,300, filed on Jul. 25, 2006.

(51) Int. Cl. H02M 1/12

(52) U.S. Cl. 363/39

(57) ABSTRACT

A power supply system with transient suppression includes an uninterruptible power supply (UPS). A power conditioning circuit is coupled to the UPS for conditioning power supplied by a power source at a nominal frequency over line, neutral, and ground conductors, respectively. The power conditioning circuit includes first, second, and third inductors coupled in series between the line, neutral, and ground conductors, respectively, and the first, second, and third power conditioning circuit output lines, respectively. All of the power supplied by the power source to the first, second, and third output lines flows through the first, second, and third inductors. Each of the inductors blocks power at frequencies greater than the nominal frequency from reaching the first, second, and third output lines.

### CROSS REFERENCE TO RELATED APPLICATIONS

This application claims the benefit of a U.S. Provisional Patent Application No. 60/820,300 entitled “Uninterruptible Power Supply With Transient Suppression,” filed on Jul. 25, 2006.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

The present invention relates generally to power conditioning circuits, and more particularly to uninterruptible power supply systems including power conditioning circuits that protect attached load equipment from transients due to, for example, lightning strikes or other power disturbances.

### SUMMARY OF THE INVENTION

According to one embodiment, a power supply system with transient suppression includes an uninterruptible power supply (UPS). A power conditioning circuit is coupled to the UPS for conditioning power supplied by a power source at a nominal frequency over line, neutral, and ground conductors, respectively. The power conditioning circuit includes first, second, and third inductors coupled in series between the line, neutral, and ground conductors, respectively, and the first, second, and third power conditioning circuit output lines, respectively. All of the power supplied by the power source to the first, second, and third output lines flows through the first, second, and third inductors. Each of the inductors blocks power at frequencies greater than the nominal frequency from reaching the first, second, and third output lines.

According to another embodiment, a power supply system with transient suppression includes an uninterruptible power supply and a power conditioning circuit for conditioning power supplied at a nominal frequency over line, neutral, and ground conductors to first, second, and third power conditioning circuit output lines, respectively. The power conditioning circuit includes a first stage that is connected to the line, neutral, and ground conductors, wherein the first stage is adapted to provide voltage suppression. A second stage is connected to the first stage, wherein the second stage includes first, second, and third inductors coupled in series between the line, neutral, and ground conductors, respectively, and the first, second, and third output lines, respectively. All of the power supplied by the power source to the first, second, and third output lines flows though the first, second, and third inductors. Each of the inductors blocks power at frequencies greater than the nominal frequency thereby preventing power at frequencies greater than the nominal frequency from reaching the first, second, and third output lines. A third stage is connected to the second stage and further connected to the first, second, and third output lines, wherein the third stage is adapted to provide voltage suppression.

Other aspects and advantages of the present invention will become apparent upon consideration of the following detailed description.

### BRIEF DESCRIPTION OF THE DRAWINGS

FIG. 1 depicts a block diagram of an uninterruptible power supply with transient suppression;

FIG. 2 illustrates a schematic diagram of the uninterruptible power supply and transient suppression circuitry of FIG. 1; and

FIG. 3 illustrates a schematic diagram of another embodiment of an uninterruptible power supply with transient suppression.

### DETAILED DESCRIPTION OF THE DRAWINGS

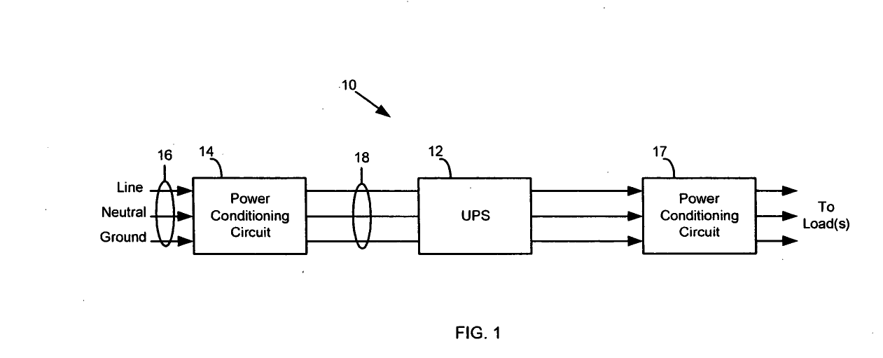

Referring to the attached FIG. 1, a power supply 10 includes an uninterruptible power supply 12 that receives conditioned power from a power conditioning circuit 14. The power conditioning circuit 14 includes line, neutral, and ground input conductors 16 coupled to line, neutral, and ground conductors of a commercial power source. The power conditioning circuit 14 may be similar or identical to that disclosed in Redburn et al., U.S. Pat. No. 6,166,458, filed Jan. 20, 1998, and assigned to the assignee of the present application, the disclosure of which is hereby incorporated by reference herein. The power conditioning circuit 14 filters transients flowing between the line, neutral, and ground input conductors 16 and the UPS 12. A further power conditioning circuit 17 is coupled to the output of the UPS 12 and may comprise one or more capacitors and/or one or more inductors complementary to the inductors in the power conditioning circuit 14 as discussed below and/or any other conditioning devices coupled between the line and neutral output conductors of the UPS 12.

The filtering provided by the circuit 14 is bidirectional in nature; specifically, transients on the line, neutral and ground input conductors 16 are prevented from flowing to the UPS 12 and transients flowing through the UPS 12 are prevented from being reflected back into the line, neutral and ground conductors 16 by the power conditioning circuit 14.

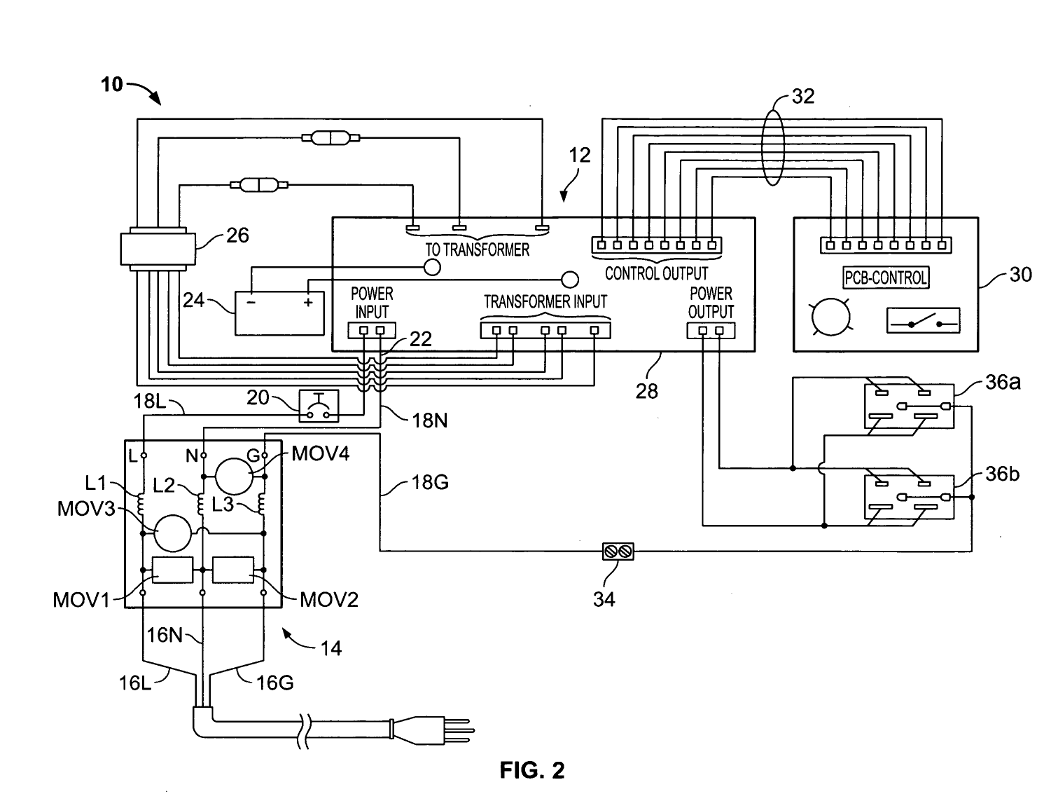

FIG. 2 illustrates the circuit of FIG. 1 in greater detail. The power conditioning circuit 14 comprises a metal oxide varistor MOV1 that is coupled between the line and neutral input conductors 16L and 16N, respectively, and a second metal oxide varistor MOV2 coupled between the neutral and ground input conductors 16N, 16G. A third metal oxide varistor MOV3 is coupled between the line and ground conductors 16L, 16G. First, second and third inductors L1, L2 and L3 are coupled in series with the line, neutral and ground input conductors 16L, 16N and 16G, respectively. A fourth metal oxide varistor MOV4 is coupled between neutral and ground output conductors 18N, 18G of the power conditioning circuit 14. In addition, a circuit breaker 20 is coupled in series with an output line 18L of the power conditioning circuit 14.

The line and neutral output conductors 18L, 18N are coupled to a plug input 22 of a conventional UPS 12. A transformer 26 is coupled between transformer input and output terminals of a main power board 28 of the UPS 12. The main power board 28 is controlled by a control board 30 via a series of conductors forming a control cable 32.

The output conductor 18G is coupled to ground screws 34 that are carried by a metal enclosure of the UPS 12. The ground screws are further coupled to ground terminals of output receptacles 36a, 36b that are connected to one or more loads. Line and neutral outputs from the main power board 28 are coupled through a plug output to line and neutral terminals of the receptacles 36a, 36b.

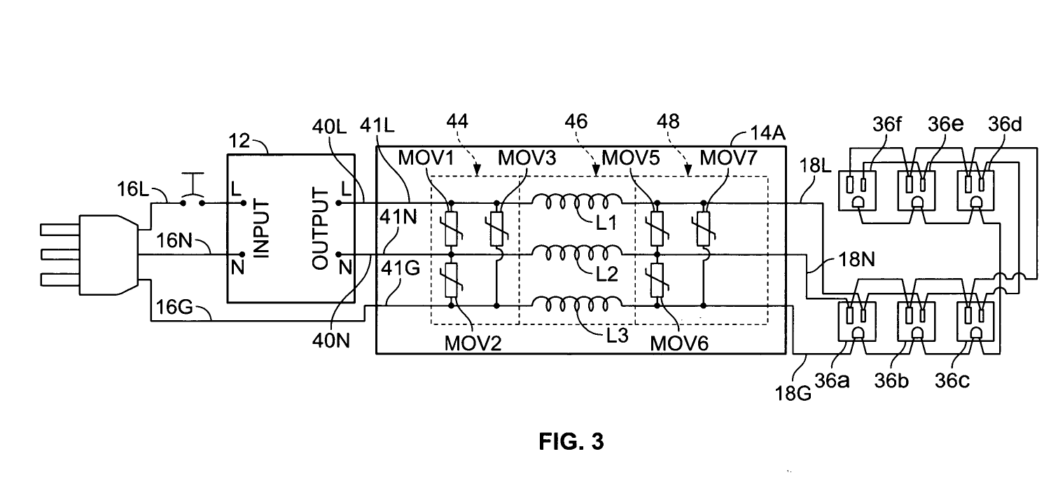

FIG. 3 depicts another embodiment of the uninterruptible power supply with transient suppression wherein elements common to FIGS. 2 and 3 are assigned like reference numerals. In this embodiment, the UPS 12 is connected to line and neutral input conductors 16L, 16N from a commercial power source upstream of the power conditioning circuit 14A (the UPS 12 is coupled downstream of the power conditioning 14 in FIG. 2). Output conductors 40L, 40N of the UPS 12 are connected to corresponding line and neutral input conductors 41L, 41N of the power conditioning circuit 14A. Input conductor 16G is connected directly to a ground input conductor 41G of the power conditioning circuit 14A. In addition to MOV1-MOV3 shown in FIG. 2, the power conditioning circuit 14A of the present embodiment includes MOV5 that is coupled between the line and neutral conductors. Still further, MOV6 is coupled between the neutral and ground conductors, and MOV7 is coupled between the line and ground conductors. Output conductors 18 of the power conditioning circuit 14A supply conditioned power to receptacles 36a-36f. The UPS 12 and the power conditioning circuit 14A are preferably otherwise identical or similar to the UPS and power conditioning circuit of FIG. 2 and operate in the same manner as described above.

Preferably, in each of the foregoing embodiments, the circuit 14 or 14A includes three stages. A first stage 44 provides voltage suppression and a second stage 46 comprising the inductors L1-L3 receives all of the power supplied by one or more upstream power source(s) (e.g., in the embodiment of FIG. 2, a power source that provides power to the conductors 16). Each inductor L1-L3 blocks power at frequencies greater than a nominal frequency. A third stage 48 provides further voltage suppression.

The uninterruptible power supply with power conditioning circuit is capable of providing clean power for sensitive loads even in the event of a power interruption, and further prevents the reflection of unwanted transients onto branch circuits resulting from the switching of one or more loads connected to the UPS.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I/We claim:

1. A power supply system with transient suppression comprising:
an uninterruptible power supply (UPS); and
a power conditioning circuit coupled to the UPS for conditioning power supplied by a power source at a nominal frequency over line, neutral, and ground conductors, respectively, wherein the power conditioning circuit includes first, second, and third inductors coupled in series between the line, neutral, and ground conductors, respectively, and the first, second, and third power conditioning circuit output lines, respectively, further wherein all of the power supplied by the power source to the first, second, and third output lines flows through the first, second, and third inductors, each of the inductors blocking power at frequencies greater than the nominal frequency from reaching the first, second, and third output lines.

2. The power supply system with transient suppression of claim 1, wherein the UPS is coupled downstream of the power conditioning circuit.

3. The power supply system with transient suppression of claim 1, wherein the UPS is coupled upstream of the power conditioning circuit.

4. A power supply system with transient suppression comprising:
an uninterruptible power supply (UPS); and
a power conditioning circuit coupled to the UPS for conditioning power supplied at a nominal frequency over line, neutral, and ground conductors to first, second, and third power conditioning output lines, respectively, wherein the power conditioning circuit includes a first stage connected to the line, neutral, and ground conductors, wherein the first stage is adapted to provide voltage suppression, a second stage connected to the first stage, wherein the second stage includes first, second, and third inductors coupled in series between the line, neutral, and ground conductors, respectively, and the first, second, and third output lines, respectively, wherein all of the power supplied by the power source to the first, second, and third output lines flows though the first, second, and third inductors, each of the inductors blocking power at frequencies greater than the nominal frequency thereby to prevent power at frequencies greater than the nominal frequency from reaching the first, second and third output lines, a third stage connected to the second stage and further connected to the first, second, and third output lines, wherein the third stage is adapted to provide voltage suppression.

5. The power supply system with transient suppression of claim 4, wherein the UPS is coupled downstream of the power conditioning circuit.

6. The power supply system with transient suppression of claim 4, wherein the UPS is coupled upstream of the power conditioning circuit.
